(19) United States
(12) Patent Application Publication
(10) Pub. No.: US 2010/0201133 A1
(43) Pub. Date: Aug. 12, 2010

(54) Zero Point Energy Rotator Transducer and Associated Methods

(76) Inventor: PAUL R. MESLER, EMERY, UT (US)

Correspondence Address: THORPE NORTH & WESTERN, LLP., P.O. Box 1219, SANDY, UT, 84091-1219, US

(21) Appl. No.: 12/541,007

(22) Filed: Aug. 13, 2009

Related U.S. Application Data
(60) Provisional application No. 61/088,913, filed on Aug. 14, 2008.

(51) Int. Cl. H02K 7/18; F03G 7/10

(52) U.S. Cl. 290/1 C; 290/1 R; 74/DIG. 9

(57) ABSTRACT

An energy conversion system for extracting energy from the zero-point field of space is disclosed and described. This system includes a primary transducer operatively associated with a secondary transducer. The primary transducer can include a substrate having an arm rotatably coupled to the substrate, while the substrate can be confined to move along a linear oscillatory path. The secondary transducer converts kinetic energy of the substrate and arm to usable energy. The multi-mode motion of the substrate and arm combination is sufficient to impart a momentum influx to rotational motion of the arm.

The momentum influx can then be converted to usable energy such as mechanical, electrical and/or thermal energy. As described in more detail herein, the momentum influx appears to be a result of radiation pressure due to scattering in part of the electro-magnetic momentum-energy contained within the zero-point field of space opposite to centripetal acceleration of the arm.

### RELATED APPLICATIONS

This application claims the benefit of U.S. Provisional Application No. 61/088,913, filed Aug. 14, 2008 which is incorporated herein by reference.

### FIELD OF THE INVENTION

This invention relates to generation of energy from the zero-point energy field of space or electromagnetic quantum vacuum. More specifically, the invention relates to a device useful for extraction of useful work via a sliding rotator. Therefore, the present invention relates generally to the fields of physics, quantum physics, and electromagnetism.

### BACKGROUND OF THE INVENTION

The now ubiquitous drive for energy independence has provided a new set of incentives and appreciation for development of environmentally and economically responsible energy resources. Conventional discussions regarding such energy resources often revolve around fossil fuels, nuclear, and “alternative energy sources” such as solar, wind, bio fuels, hydrogen, fuel cells, and the like. Each of these energy resources currently comes with various benefits and drawbacks and often entail trade-offs between perceived pollution and environmental problems, costs, efficiencies, and unintended consequences (e.g. corn demand for use as fuel versus food).

Since at least the 1960's some theoretical physicists have proposed the concept of zero-point energy which suggests a background energy field throughout space. Historically, these physicists have been at least partially marginalized by mainstream academic thought. However, over the past decade or so, such theories have begun to gain significant traction in terms of recognition and available proofs to support these theories. Although this developing area of physics has experienced progress, practical applications of such theories remain severely limited. One example of such progress in practical applications is the work of Bernard Haisch and others in capitalizing on the Casimir effect. Such efforts thus far remain relegated to the quantum level. Although a wide variety of purported devices and claims have been made, no macroscale efforts have yet proven to yield useful energy gains.

### SUMMARY OF THE INVENTION

In light of the relative infancy of the field and deficiencies noted above, the present invention provides an energy conversion system for extracting energy from the zero-point field of space. This system includes a primary transducer operatively associated with a secondary transducer. The primary transducer can include a substrate having an arm rotatably coupled to the substrate, while the substrate can be confined to move along a linear oscillatory path. The secondary transducer converts kinetic energy of the substrate and arm to usable energy. The multi-mode motion of the substrate and arm combination is sufficient to impart a momentum influx to a rotational motion of the arm. The momentum influx can then be converted to usable energy such as mechanical, electrical and/or thermal energy. As described in more detail herein, the momentum influx appears to be a result of radiation pressure resulting from scattering in part of the electro-magnetic momentum-energy contained within the zero-point field of space opposite to centripetal acceleration of the arm.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention and they are, therefore, not to be considered limiting of its scope. It will be readily appreciated that the components of the present invention, as generally described and illustrated in the figures herein, could be arranged, sized, and designed in a wide variety of different configurations. In particular, relative dimensions may vary and are generally not presented in an optimized configuration but are rather provided for clarity and convenience in describing the invention generally. Nonetheless, the invention will be described and explained with additional specificity and detail through the use of the accompanying drawings in which:

FIG. 1 is a schematic of an energy conversion system in accordance with one embodiment of the present invention.

FIG. 2 is a schematic of an energy conversion system having two rotating arms, one rotating clockwise and the other counterclockwise, in accordance with another embodiment of the present invention.

FIG. 3 is a schematic of an energy conversion system illustrating an electro-magnetic mechanism for accelerating the arm in accordance with yet another embodiment of the present invention.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

### Definitions

In describing and claiming the present invention, the following terminology will be used.

The singular forms “a,” “an,” and “the” include plural referents unless the context clearly dictates otherwise. Thus, for example, reference to “an arm” includes reference to one or more of such members and reference to “converting” refers to one or more such steps.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

In the present disclosure, the term “preferably” or “preferred” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Embodiments of the Invention

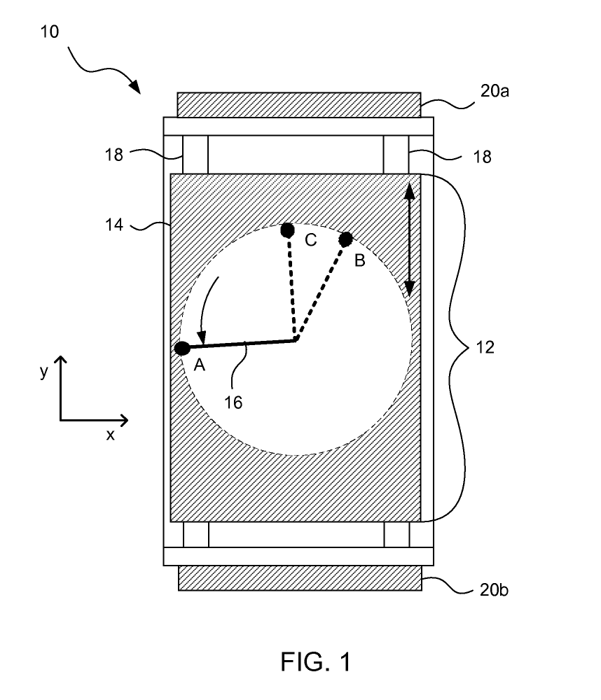

Referring now to FIG. 1, an energy conversion system 10 is shown generally for extracting energy from the zero-point field of space. The system can include a primary transducer 12 which is designed to extract energy from the zero-point field of space in the form of kinetic energy. Multi-mode motion can be induced in a primary transducer along an oscillatory path. The multi-mode motion can include a primary translational motion and a secondary motion such that abrupt changes in the primary translational motion are sufficient to impart a momentum influx to the secondary motion. In one embodiment, the primary transducer can include a substrate 14 having an arm 16 rotatably coupled to the substrate. The substrate is generally confined to move along an oscillatory path. A secondary transducer 20a can be operatively associated with the primary transducer to covert the momentum influx into usable energy. Thus, the systems of the present invention provide an energy conversion system for extracting energy from the zero-point field of space. Generally, the system includes a means for extracting momentum-energy from vacuum by the action of inertia and a means for converting the momentum-energy to usable energy operatively associated with the means for extracting momentum-energy.

More particularly, the substrate 14 can be any suitable member upon which a rotating arm 16 can be coupled or otherwise mounted. The substrate can be guided along the oscillatory path by any suitable mechanism such as, but not limited to, tracks, walls or the like. FIG. 1 shows a linear oscillatory path defined by a pair of tracks 18 along which the substrate can move. The substrate can move along the tracks via bearings, wheels, magnetically repulsive members, or any other suitable approach. Typically, it is most desirable to minimize friction between the substrate and tracks in order to maximize energy transfer to the secondary transducer. The substrate and arm can be formed of any suitable material which can be readily chosen based on designed parameters to meet various property requirements such as density, fracture strength, toughness, etc. Furthermore, the shape and contours of the substrate and arm can also be designed to minimize aerodynamic resistance due to the significant acceleration forces per unit of time experienced by the primary transducer.

In one aspect of the present invention, the substrate has a substrate mass (m₂) and the arm has an arm mass (m₁) such that a ratio of m₂ to m₁ is chosen to maximize a gain in kinetic energy (ΔKE) of the substrate. The rotating arm acts as the primary momentum influx extraction mechanism which experiences an inertial force acting opposite to the centripetal force acting on the rotating arm. A fraction of the inertial force is manifest at an axis of rotation which is rigidly attached to the substrate and which constrains the arm to rotate around this axis. The y-component of this force acting on the axis, denoted as the centrifugal reactive force, imparts an impulse on the substrate in the positive y-direction with respect to an x-y coordinate system when the arm rotates within the first quadrant of the said x-y coordinate system or imparts an impulse on the substrate in the negative y-direction when the arm rotates within the third quadrant of the said x-y coordinate system, such that the substrate experiences a net time-rate influx of momentum from the zero-point energy field of space or an increase in the momentum of the substrate in either the positive or negative y-direction, depending on which quadrant the arm is rotating in.

The oscillatory path can be a linear track 18 which defined on both ends by a pair of resilient stationary members 20a and 20b oriented on either end of the linear track. During operation of the system, the primary transducer oscillates back and forth between the two stationary members. The approach at each end is accompanied by a transfer of kinetic energy of the primary transducer (e.g. substrate and arm) to the secondary transducer. The primary transducer can thus be coupled to the secondary transducer in a manner which allows for conversion of this kinetic energy to the secondary transducer. For example, this can be accomplished by providing an at least partially or substantially inelastic collision with the resilient stationary members. As discussed in more detail below, various mechanisms can be effectively used to convert kinetic energy of the primary transducer into usable energy, e.g. via mechanical, thermal, and/or electromagnetic features.

As can be readily appreciated, the arm and substrate need an initial input of energy from an external source to begin movement. The source of energy to initiate rotation of the arm can come from a conventional energy source, such as a battery. This external energy can be transferred to the arm such as by a coaxial motor, magnetic accelerator, external flywheel, or the like. For example, a drive motor can be operatively associated with the arm and configured to initiate rotational motion of the arm and sustain the rotational motion at a predetermined critical angular velocity. Another option is to provide a permanent magnet on the arm, e.g. at the free end, and a complimentary magnetic induction coil at a location external to the primary transducer. In this manner, an electric current applied to the induction coil creates a magnetic field sufficient to act on the permanent magnet and accelerate the arm. After a critical angular velocity is reached, the external source of energy (such as a battery, the power grid, etc.) for the motor or other suitable initiator mechanism can be switched to an alternative energy storage device such as collected energy.

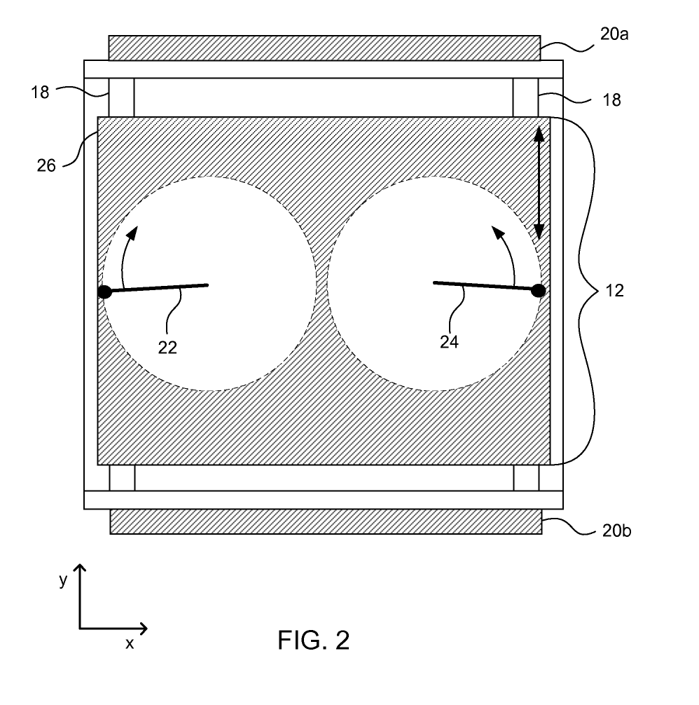

Referring now to FIG. 2, an alternative embodiment of the present invention is shown including an arm 22 and a secondary arm 24 each rotatably coupled to the substrate. In one embodiment, the secondary arm has an axis of rotation spaced apart from an axis of rotation of the arm 22. Alternatively, the secondary arm could share a common axis of rotation. In either case, the secondary arm is coupled to the arm such that both the arm and the secondary arm rotate at a common angular velocity and opposite rotational directions. Typically, the secondary arm also has a substantially identical mass and dimensions to that of the arm. In other words, the arms swing forward and back in the same cycle, with common y-coordinates and mirror x-coordinates.

In one embodiment, a motor can drive the first arm, and the second arm can be driven by gears linked to the first arm, such that they are in sync with each other, rotating at the same angular speed but in opposite rotational directions. In such cases, the cosines of the rotation angle of each arm will always be equal in magnitude, but opposite in sign. Thus, the x-components of the centrifugal reactive force acting on each axis would be equal and opposite in direction, and therefore, they would cancel each other. As a result, the substrate having two rotating arms will not impart compressive forces on the corresponding linear track along the x-axis during operation of the system.

The kinetic energy of the primary transducer can be converted to usable energy twice for every full rotation of the arm(s), i.e. once between the 0° position and the 90° position and once between the 180° and the 270° position. The optimal position of the arm at impact of the substrate with the stationary member can vary but is generally in these ranges. Specifically, as the arm approaches 90° or 270° the gain approaches 0 (see Example, Equation 3). Similarly, the momentum of the substrate at 0° and 180° is also 0 so the gain at those points would also be 0. A suitable secondary transducer can thus be coupled with the primary transducer as a means for converting kinetic and momentum-energy of the substrate and arm into usable energy such as electrical, mechanical, or thermal energy. The secondary transducer can be an electromagnetic induction system, mechanical gear system, heat transfer system, piezoelectric system, or the like. For example, the means for converting the momentum-energy can be an induction coil system, heat dissipater, magnetic brake, friction brake, or linear to rotational motion translator. A heat dissipater can include a substantially inelastic collision between the substrate and a set of bumpers. Heat generated by collision can be converted to energy through heat transfer to produce steam which can be used to drive a turbine, or other similar thermo-electric conversion devices.

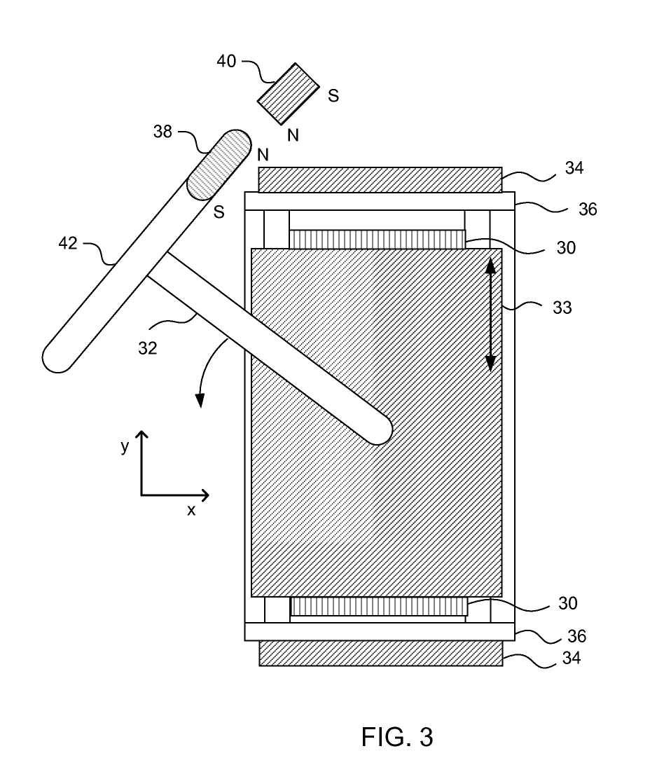

In one specific embodiment of the present invention, the secondary transducer includes at least one induction coil system including a magnet and a complimentary conductive coil. The magnet can be physically coupled to the substrate and oriented to approach the complimentary conductive coil sufficient to induce electrical current therein during movement of the substrate along the oscillatory path. A similar magnet system can be incorporated into the arm as well. Such a secondary transducer can also be utilized as the initiator system by switching the energy source, i.e. from an external battery to energy derived from the zero-point energy field. FIG. 3 illustrates a simplified version of such an electromagnetic-kinetic energy conversion system for the secondary transducer. In particular, a permanent magnet 30 can be coupled to each collision end of the substrate 33 having the arm 32 rotatably coupled thereto. An external induction coil 34 can be oriented at a position (or positions) to allow the kinetic energy of the substrate to be progressively converted to electrical energy at each approach of the substrate to the stationary members 36. In another embodiment, a piezoelectric material such as a crystal or ceramic can be coupled to the stationary member. The force applied by the substrate to the piezoelectric material can generate an electric potential in response to the applied mechanical stress. Alternatively, the secondary transducer can include a mechanical coupling between the substrate and an energy translator. The energy translator can be a linear-to-rotational motion drive, heat surfacing, or rack and pinion, although other mechanisms may also be suitable.

After the substrate collides with either of the stationary members, the arm's rotational speed can be replenished by a suitable arm accelerator. For example, an electro-magnet system can be oriented with a permanent magnet 38 at the free end of the arm with a corresponding external induction coil 40. In this case, the arm can have a t-shape to allow the permanent magnet to be oriented substantially in-line with the magnetic field produced by the external electro-magnet (although opposite signs). This allows for a maximum transfer of kinetic energy to the arm from the electro-magnet acceleration system. Alternatively, the permanent magnet and induction coil can be swapped. Typically, the t-portion 42 can have substantially equal mass on either end such that the center of mass lies along the arm axis. This electro-magnet can impart an impulsive torque to the arm in either the second or fourth quadrant (or at any point right after the collision of the substrate with a stationary member) as the permanent magnet attached to the arm passes closely to the electro-magnet. The advantage of this approach is that the arm's rotation will be maintained substantially by electro-magnetism without additional gears or mechanical losses due to the friction of such gears. This replenishment of the rotational speed of the arm can optionally be achieved by a motor in the second and fourth quadrant (or at any point right after the collision of the substrate with a stationary member) by using pulsed technology, wherein the power to the motor is only turned on in the second or fourth quadrant.

In operation, the movement of the substrate can follow a linear oscillatory path having two endpoints while the arm(s) follows a cyclic path such that translational motion of the substrate in a y-direction along the oscillatory path substantially coincides with translational motion of the arm in the y-direction. Furthermore, the arm has two theoretical maximum energy transfer positions, the positions occurring twice for every cycle of rotation of the arm. Actual maximum energy transfer positions can be empirically determined and a collision swing angle adjusted to obtain a substantially maximum in the usable energy, depending on the specific design, i.e. relative masses, arm length, rotational velocity, etc.

There are at least two factors that impact the overall maximum energy gain of the system. For example, the substrate's final kinetic energy before collision with a stationary member partly determines the maximum energy gain of the system. Maximum energy gain is also determined by the angular displacement of the arm at the time of the collision, the angular velocity of the arm, the linear velocity of the substrate prior to collision and the relative masses of the arm and substrate.

During operation of the system, a full cycle of rotation of the rotator can be divided into the four conventional quadrants counter-clockwise. Upon start-up, the arm is initiated with a battery driven motor (or equivalent, such as an electro-magnet system) to reach a terminal velocity while holding the slider substrate stationary. The terminal velocity is determined by the friction in the system and the power transfer capabilities of the device that delivers power to the rotator to keep it rotating. After the rotator has reached this constant velocity, integrated sensors in the system release the slider just prior to the rotator arriving at its 0 degree position. The slider will begin to accelerate when the y-component of the centrifugal reactive force acting on the physical vertical axis attached to the slider is greater than any static friction force between the slider and its linear track. The angle of the rotator with respect to the x-axis at which angle the slider begins to accelerate is denoted as phi. During this first quadrant rotation of the rotator, the power to the motor can be optionally turned off so that the rotator continues to rotate on its own rotational inertia.

The distance between the front and back secondary transducers or stationary members can be adjusted such that the slider “collides” with this secondary front transducer when the rotator has rotated an angle less than 90 degrees (e.g. 15° to 75° although other ranges may be useful such as about)45° with respect to the x-axis which gives a maximum transfer of energy.

In one embodiment, the secondary transducer can comprise a linear generator. The linear generator can include a coil or set of coils receiving the magnets attached to the slider, and all of the electronic and electrical circuitry associated with the linear generator must be able to handle a brief impulse of power if the slider is to come to a near stop quickly. The linear generator can be designed of sufficiently robust materials and capacity to handle this power surge. Alternatively, the secondary transducer can include a thermal conversion system or a piezoelectric device, as previously discussed. More particularly, the stationary members and substrate can be designed to provide a substantially inelastic collision such that much of the kinetic energy of the substrate is converted to heat or electricity. In a thermal conversion process, the substrate and stationary member can accordingly be thermally linked to a water reservoir such that water is heated to steam, which drives an electrical generator.

A thermal conversion process may be more effective for a large scale energy conversion system. A piezoelectric conversion process may be more useful for a small scale energy conversion system, such as an energy conversion system used in a micro-machine or other type of micro-electro-mechanical system (MEMS).

After the slider comes to a complete stop after the collision of the slider with a stationary member a pulsed power source can be used to replenish the speed of the rotator back to its initial speed. There will typically be a loss in speed of the rotator due to friction and a replenishment of the speed of the rotator must happen twice every cycle after every collision of the slider with a stationary member.

Based on the guidance provided herein, a speed of the rotational motion, relative masses of the arm and the substrate, geometry of the arm, and the geometry of the substrate can all be designed such that zero-point energy is utilized to maintain the movement of the substrate. Non-limiting examples of specific variables which can be adjusted include aerodynamic shape of the arm and substrate, length of the arm, materials of construction, density of substrate and arm, and the like.

Theoretical Background

Without being bound to any particular theory, it is thought that the principles of operation of the present invention are governed by a theoretical backdrop described in more detail below. In summary, this theoretical backdrop indicates that the momentum influx to the primary transducer is a result of radiation pressure due to scattering in part of the electromagnetic momentum-energy contained within the zero-point field of space opposite to the centripetal acceleration of the arm. The systems of the present invention can be sized and incorporated into a wide variety of applications which are currently occupied by conventional energy sources, e.g. batteries, power generators, fuel cells, and so forth. A more in depth description of one theory follows; however, it is understood that the following description is not exclusive, exhaustive or definitive of the underlying inventive concept.

We begin a discussion with a rotating point particle with a mass of m₁, and denote it as the rotator. One end of the rotator is attached to a vertical axis by a mass-less wire of length r, so that the rotator rotates freely counter-clockwise around this axis with two degrees of freedom in a plane parallel to the earth. The vertical axis is rigidly attached to a second object denoted as the slider with mass m₂. The slider is constrained to move along a linear track with one degree of freedom, coincident to the y-axis of an x-y Cartesian coordinate system. Initially, the axis of rotation is set at the origin of the coordinate system.

The rotator is aligned coincident with the x-axis of the x-y coordinate system, such that the rotator is located at 180 degrees with respect to the x-axis. The slider presses against a back bumper so that the slider cannot move in the negative y-direction. An impulse is applied on the rotator in the negative y-direction, causing the rotator to rotate counter-clockwise. The rotator rotates until it passes the 0 degrees point, and the slider moves in the positive y-direction at some angle after this 0 degrees point. Immediately prior to the movement of the slider, the initial tangential velocity of the rotator is denoted as vᵢ. A short time interval later as the slider moves in the positive y-direction, the slider is allowed to make an inelastic collision with a front bumper at some angle θ of the rotator with respect to the x-axis. The tangential velocity of the rotator prior to the collision of the slider is denoted as v_{α}. The post-collision tangential velocity of the rotator is denoted as v_{f}. The linear velocity of the slider prior to the collision of the slider is denoted as vₛ.

The initial tangential kinetic energy of the rotator is:

KE_{rotator initial}½m₁vᵢ² (1).

With respect to the laboratory frame this represents the initial energy of the rotator-slider system. As the slider accelerates forward in the positive y-direction under the action of the y-component of the centrifugal reactive force on the axis, both the slider and the rotator acquire an equal instantaneous linear velocity in the positive y-direction, and therefore, a linear kinetic energy with respect to the laboratory frame. By the conservation of energy, the tangential kinetic energy of the rotator must decrease, such that:

ΔKEᵣₒₜₐₜₒᵣ=KE_{linear slider}+KE_{linear rotator} (2).

Or:

½m₁vᵢ²−½m₁v_{α}²=½m₂vₛ²+½m₁vₛ² (2a).

Rearranging, we have:

½m₁vᵢ²−½m₁v_{α}²=½m₂vₛ²+½m₁vₛ² (3).

That is, by the conservation of energy the pre-collision total kinetic energy observed in the system must equal the initial kinetic energy of the rotator.

Upon collision of the slider with the front bumper, the kinetic energy of the slider equal to ½ m₂ vₛ² is essentially converted to thermal energy. The linear kinetic energy of the rotator is accounted for as follows.

Taking θ as the angle of the rotator at the time of collision, and by application of the Pythagorean Theorem, we have:

½m₁vₛ²=½m₁ sin²θvₛ²+½m₁ cos²θvₛ² (4).

The first term on the right side of the above equation represents the kinetic energy of the slider transformed to thermal energy upon collision of the slider. It is reasonable to assume that the energy described by the second term transfers and adds to the tangential kinetic energy of the rotator.

The tangential kinetic energy of the rotator just prior to the collision is:

KE_{rotator α}=½m₁v_{α}² (5).

Adding the second term on the right of equation 4 to equation 5 to obtain the final post-collision tangential kinetic energy of the rotator, the answer would be:

KE_{rotator post collision}=½m₁v_{α}²+½m₁ cos²θvₛ² (6).

However, the above equation is incorrect because it was assumed the second term could be used in equation 4 to obtain the final result. This equation, derived from the Pythagorean Theorem, is correct from a conservation of energy perspective, but it cannot be used for post-collision analysis. The post-collision tangential kinetic energy of the rotator must first be obtained by vector addition of vector entities.

The correct procedure is as follows. Just prior to the collision of the slider, the rotator has a linear velocity in the positive y-direction equal to the linear velocity of the slider. Thus, the rotator has a linear momentum in the positive y-direction equal to:

pᵣₒₜₐₜₒᵣ=m₁vₛ (7).

At collision, a part of this momentum is transferred to the front bumper or the earth, and the amount of momentum transferred is equal to:

p_{bumper}=sin θm₁vₛ (8).

By the conservation of angular momentum the remaining momentum is transferred to the rotator, such that there is an increase in the post-collision angular momentum of the rotator, equal to:

m₁v_{f}r=m₁v_{α}r+m₁ cos θvₛr (9).

Dividing both sides of the above equation by m₁ and r, we obtain:

v_{f}=v_{α}+cos θvₛ (10).

Using the above, the correct expression for the final post-collision tangential kinetic energy of the rotator is derived, equal to:

KE_{rotator pst collision}=½m₁v_{α}²+m₁v_{α} cos θvₛ+½m₁ cos²θvₛ² (11).

Now, recalling equation 6, we have:

KE_{rotator post collision}=½m₁v_{α}²+½m₁ cos²θvₛ²

Subtracting the above two equations, the difference is obtained as:

m₁v_{α} cos θvₛ

Recalling equation 3:

½m₁vᵢ²=½m₁v_{α}²+½m₂vₛ²+½m₁vₛ²

Substitute equation 4 into the last term of the above, giving:

½m₁vᵢ²=½m₁v_{α}²+½m₂vₛ²+½m₁ sin²θvₛ²+½m₁ cos²θvₛ²

Regroup the above as follows:

½m₁vᵢ²=(½m₂vₛ²+½m₁ sin²θvₛ²)+(½m₁v_{α}²+½m₁ cos²θvₛ²) (12).

This is the correct equation for the total energy of the system prior to the collision of the slider. Now take equation 12 and substitute equation 11 for the last two terms in the last parentheses, giving the total energy of the system after the collision of the slider:

KE_{system final}=(½m₂vₛ²ₜₑ+½m₁ sin²θvₛ²ₜₑ)+(½m₁v_{α}²+m₁v_{α} cos θvₛ+½m₁ cos²θvₛ²) (13).

Where, the subscript represents the thermal energy transformed from kinetic energy after the collision of the slider.

The left side of equation 12 represents the initial tangential kinetic energy of the rotator or the initial total energy of the system prior to collision. Equation 13 represents the total energy of the system after the collision. Clearly, there has been a gain in the total energy of the system by the amount of:

ΔE=m₁v_{α} cos θvₛ

Substituting v_{β} for cos θvₛ, the above can be expressed as:

ΔE=m₁v_{α}v_{β}

By the first law of thermodynamics there must be an influx of energy-momentum to the system to account for this gain in energy. One possible explanation for the influx may be found in a paper that postulates inertia is due to a time rate change of incoming momentum flux to an accelerating object from the vacuum energy-momentum of space (A. Rueda & B. Haisch, Contribution to inertial mass by reaction of the vacuum to accelerated motion, Foundations of Physics, Vol. 28, No. 7, pp. 1057-1108 (1998) which is incorporated herein by reference). The paper states:

We demonstrate that from the point of view of a nearby inertial observer there exists a net energy and momentum flux (Poynting vector) of ZPF radiation transiting the accelerating object in a direction necessarily opposite to the acceleration vector. The scattering opacity of the object to the transiting flux creates the back-reaction force customarily called the inertial reaction.

If the above is true, then at the time of the collision of the slider an influx of momentum from the vacuum transits the rotator in the positive y-direction, opposite to the instantaneous linear de-acceleration of the rotator and slider in the negative y-direction. A portion of this momentum, equal to m₁ cos θvₛr, transfers to the rotator and increases its angular momentum by an amount found in equation 9, which was derived as a consequence of the conservation of angular momentum.

It has been known since the last century that energy has inertia implied by Einstein's equation E=m₀c². Rearranging the equation, we see the mass equivalent of energy expressed as E/c²=m₀. That is, energy in the form of radiation can interact with physical objects as if the energy had the properties of material objects—momentum, etc. Hence, if we assume space is filled with an irrepressible average minimum vacuum energy as predicted by the Heisenberg uncertainty principle in part composed of electro-magnetic radiation, the interaction of accelerating objects with the photons comprising this radiation could indeed create a reaction force. For example, a photon contains momentum equal to:

p=hv/c

It is conceivable that photons “colliding” with the rotator opposite to the instantaneous linear de-acceleration of the rotator could transfer part of their momentum to the rotator. And if this were true, along with a transfer of momentum, energy would necessarily transfer also. For example, in the relativistic expression relating the relationship between kinetic energy and momentum we have:

(K+m₀c²)²=(pc)²+(m₀c²)²

Reduced to the Newtonian limit, the above can be expressed as:

K=(p)²/(2m₀)

Hence, any increase in the angular momentum of the rotator due to this transfer of momentum from the vacuum must be accompanied by an increase in kinetic energy with respect to a laboratory frame.

The above explanation is more plausible than any Machian explanation. One may incorrectly argue that the increase in energy is due to linear frame-dragging, the so-called Lens-Thirring effect, predicted by the general theory of relativity. To date, the Gravity Probe B experiment has not conclusively proven this effect, but even if it did, it would not have any bearing on this discussion. The frame-dragging effect is only observed in the de-accelerating frames of the rotator and the slider as the slider collides with the front bumper. It is not observed in the frame of the laboratory because the mass of the universe is obviously not accelerating with respect to this frame. To insist this effect must apply to the laboratory frame would violate the principle of relativity by implying the de-accelerating frames of the rotator and slider are preferred frames and the effects observed in these frames must be imposed in the frame of the laboratory. An explanation that only applies to the laboratory frame is demonstrated below.

### Example

An experiment was performed to test if energy gain occurred in a rotator-slider system. The experiment tested two hypotheses. The momentum influx hypothesis (MIH) asserted there would be a gain in the post-collision rotational energy of the rotator, and therefore, a gain in the energy of the system as a whole by the action of an influx of energy-momentum to the system via inertia. The null hypothesis or classical hypothesis (CH) asserted there would be no gain in energy of the post-collision rotational energy of the rotator, and therefore, there would be no gain in the system as a whole. The null hypothesis was designated as the classical hypothesis because it takes the classical Newtonian assumption that inertia is an intrinsic property of matter, and therefore, could never affect a gain in energy of any system. The momentum influx hypothesis takes the position that inertia is an extrinsic property of matter a link to the vacuum energy of space under the right conditions. In the experiment the rotator is a physical object. The equations derived in this paper were derived for a point particle. Thus, we must modify the equations previously demonstrated by including the moment of inertia of the rotator.

Expressed mathematically, the CH maintains the following:

½Iωᵢ²=½m₂vₛ²+½m₁ sin²θvₛ²+(½Iω_{α}²+½m₁ cos²θvₛ²) (1).

The above essentially states that the post-collision energy of the rotator, the terms in parentheses, when added to the other terms, equals the initial rotational kinetic energy of the system. Thus, the energy of the system is conserved.

The MIH is expressed mathematically as:

$${E}_{final} = \frac{1}{2} {m}_{2} {v}_{s} + \frac{1}{2} {m}_{1} {sin}^{2} θ {{v}_{s}}^{2} + ( \frac{1}{2} I {{ω}_{α}}^{2} + \frac{I {ω}_{α} cos 0 {θv}_{s}}{r} + \frac{I {cos}^{2} {{θv}_{s}}^{2}}{2 {r}^{2}} ) . \qquad ( 2 )$$

The terms in parentheses above represent the post-collision energy of the rotator derived from the conservation of angular momentum. When added to the remaining terms, the above is greater than equation 1 by the following, which expresses the gain in energy of the system:

$$Δ E = \frac{I {ω}_{α} cos θ {v}_{s}}{r} + \frac{I {cos}^{2} {{θv}_{s}}^{2}}{2 {r}^{2}} - \frac{{m}_{1} {cos}^{2} θ {{v}_{s}}^{2}}{2} . \qquad ( 3 )$$

Where:

I=the moment of inertia of the rotator

ω_{α}=the angular velocity of the rotator prior to collision

θ=the angle of the rotator at the time of collision

vₛ=the linear velocity of the slider prior to collision

r=the distance from the axis to the center of mass of the rotator

In the experiment the post-collision energy of the rotator was measured and compared to the MIH and CH prediction. The collected data is in Table 1 while the results are presented in Table 2.

In Table 1 and Table 2 the following terms are defined:

ω_{α}=the measured angular velocity of the rotator prior to collision

θ=the measured angle of the rotator at the time of collision

vₛ=the measured linear velocity of the slider prior to collision

ωᵢ=the measured initial angular velocity of the rotator

ω_{f}=the measured final post-collision angular velocity of the rotator

keᵢ=the measured initial kinetic energy of the rotator

ke_{α}=the measured kinetic energy of the rotator prior to collision

ke_{f}=the measured final kinetic energy of the rotator after collision

m₁=the mass of the rotator

m₂=the mass of the slider

I=the moment of inertia of the rotator

r=the radial distance from the axis to the center of mass of the rotator

m₁ was 3.89 kg, m₂ was 1.97 kg, l was 0.403 kg m², and r was 0.314 m.

TABLE 1

| ω_{α} | θ | vₛ | ωᵢ | ω_{f} | keᵢ | ke_{α} |
|---|---|---|---|---|---|---|
| 8.80 | 32.0 | 0.294 | 9.81 | 9.72 | 19.4 | 15.6 |
| 8.80 | 34.5 | 0.450 | 9.54 | 9.44 | 18.3 | 15.6 |
| 7.30 | 39.0 | 0.540 | 8.89 | 8.71 | 15.9 | 10.7 |
| 7.33 | 45.0 | 0.622 | 9.62 | 9.17 | 18.6 | 10.8 |

TABLE 2

| ke_{f} (J) | MIH Prediction (J) | CH Prediction (J) | Net over CH (J) |
|---|---|---|---|
| 19.0 | 20.2 | 15.73 | 3.3 |
| 18.0 | 21.5 | 15.87 | 2.1 |
| 15.3 | 16.2 | 11.08 | 4.2 |
| 16.9 | 16.3 | 11.20 | 5.7 |

As can be seen, the net gain over CH predicted values was from about 13% to about 50%.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. An energy conversion system for extracting energy from the zero-point field of space, comprising:
a) a primary transducer including a substrate having an arm rotatably coupled to the substrate, said substrate being confined to move along an oscillatory path; and
b) a secondary transducer operatively associated with the primary transducer, the secondary transducer converting kinetic energy of the substrate and arm to usable energy.

2. The system of claim 1, wherein the oscillatory path is a linear track defined by a pair of resilient stationary members oriented on both ends of the linear track.

3. The system of claim 1, further including a drive motor operatively associated with the arm and configured to initiate rotational motion of the arm and sustain the rotational motion at a critical angular velocity.

4. The system of claim 2, wherein the substrate has a substrate mass (m₂) and the arm has an arm mass (m₁) such that a ratio of m₂ to m₁ is chosen to maximize a gain in kinetic energy (ΔKE) of the substrate and the arm.

5. The system of claim 1, further comprising a secondary arm rotatably coupled to the substrate and having a secondary axis of rotation spaced apart from an axis of rotation of the arm, said secondary arm being coupled to the arm such that both the arm and the secondary arm rotate at a common angular velocity and opposite rotational directions, and wherein the secondary arm has a substantially identical mass and dimensions to that of the arm.

6. The system of claim 5, wherein the secondary arm rotates about a common axis of rotation with the arm.

7. The system of claim 1, wherein the secondary transducer includes at least one induction coil system including a magnet and a complimentary conductive coil, such that the magnet is physically coupled to the substrate and oriented to approach the complimentary conductive coil sufficient to induce electrical current therein during movement of the substrate along the oscillatory path.

8. The system of claim 1, wherein the secondary transducer includes piezoelectric material operable to convert a force applied by the substrate to the secondary transducer to an electric potential in response to applied mechanical stress.

9. The system of claim 1, wherein the secondary transducer includes a mechanical coupling between the substrate and an energy translator.

10. The system of claim 9, wherein the energy translator is a linear to rotational motion drive, heat surfacing, or rack and pinion.

11. The system of claim 1, wherein the usable energy is mechanical, thermal and/or electrical energy.

12. An energy conversion system for extracting energy from the zero-point field of space, comprising a means for extracting momentum-energy from vacuum by the action of inertia and a means for converting the momentum-energy to usable energy operatively associated with the means for extracting momentum-energy.

13. The system of claim 12, wherein the means for extracting momentum-energy is a substrate having an arm rotatably coupled to the substrate which substrate is confined to move along an oscillatory path.

14. The system of claim 12, wherein the means for converting the momentum-energy is an induction coil system, heat dissipater, magnetic brake, friction brake, or linear to rotational motion translator.

15. A method of extracting energy from the zero-point field of space, comprising:
a) inducing rotational motion of an arm rotatably mounted to a substrate which is confined to move along an oscillatory path and wherein the rotational motion is sufficient to impart movement of the substrate along the oscillatory path; and
b) converting momentum-energy of the substrate to usable energy.

16. The method of claim 15, wherein a speed of the rotational motion, relative masses of the arm and the substrate, geometry of the arm, and the geometry of the substrate are designed such that zero-point energy is utilized to maintain the movement of the substrate.

17. The method of claim 15, wherein the inducing is accomplished by a drive motor.

18. The method of claim 15, wherein the movement of the substrate follows a linear oscillatory path having two endpoints and the arm follows a cyclic path such that translational motion of the substrate in a y-direction along the oscillatory path substantially coincides with translational motion of the arm in the y-direction.

19. The method of claim 18, wherein the arm has two theoretical maximum energy transfer positions that occur twice each full cycle of the arm, corresponding to two angles of the arm with respect to an x-axis, which angles occur simultaneously at the time of collision of the substrate with a stationary member.

20. The method of claim 15, wherein the step of converting is accomplished by inductive coupling of conductive wire and at least one magnet.

21. The method of claim 15, wherein the usable energy is mechanical, thermal and/or electrical energy.

22. The method of claim 15, further comprising inducing rotational motion in a secondary arm in an opposite direction to that of the arm such that motion along the oscillatory path of each of the arm and the secondary arm substantially coincide with each other.

23. A method of extracting energy from the zero-point field of space, comprising:
a) inducing multi-mode motion in a primary transducer along an oscillatory path, wherein the multi-mode motion includes a primary translational motion and a secondary motion such that abrupt changes in the primary translational motion are sufficient to impart a momentum influx to the secondary motion; and
b) converting the momentum influx to usable energy.

24. The method of claim 23, wherein the momentum influx is a result of radiation pressure due to scattering in part of the electro-magnetic momentum-energy contained within the zero-point field of space opposite to centripetal acceleration of the arm.
